(19) United States
(12) Patent Application Publication
(10) Pub. No.: US 2006/0006024 A1
(43) Pub. Date: Jan. 12, 2006

(54) Step ladder having a top step with magnetic properties

(76) Inventor: Matthew Till, Attleboro, MA (US)

Correspondence Address: KRIEGSMAN & KRIEGSMAN, 665 Franklin Street, Framingham, MA, 01702, US

(21) Appl. No.: 10/886,890

(22) Filed: Jul. 8, 2004

(51) Int. Cl. E06C 5/32

(52) U.S. Cl. 182/129

(57) ABSTRACT

A step ladder having a pair of rear legs, a pair of front legs, a plurality of cross pieces connecting the two front legs at different levels and a plurality of steps which are fixedly attached to the rear legs at different levels. The plurality of steps includes a top step which in addition to being fixedly attached to the pair of rear legs is pivotally attached to the pair of front legs. The top step comprises a plate of plastic, the plate having a top surface and a bottom surface. A magnetic member for magnetically holding ferrous objects which may be placed on the top surface of the top step is permanently fixed to the plastic plate. The magnetic member may either comprise a bar magnet or a panel of magnetic sheeting or magnetic particles. The magnetic member may either be fixedly attached to the bottom surface of the top step, fixedly attached to the top surface of the top step or imbedded into the top step itself.

### BACKGROUND OF THE INVENTION

The present invention relates generally to ladders and more particularly to step ladders.

Step ladders are a well know and widely used type of ladder. Step ladders usually include a pair of rear legs, a plurality of steps, including a top step, attached to the pair of rear legs at different levels, a pair of front legs attached to the top step and a plurality of cross pieces connecting the two front legs at different locations. These ladders may also include a fold out tray as well as brackets for interconnecting the front and rear legs at intermediate locations.

It is common practice for carpenters, painters and the like to use a step ladder to accomplish their work. Very often, the user will place his tools, accessories, or work materials on the top step of the ladder. The problem with this practice is that the tool, accessory or work materials will often fall or roll off of the top step, especially when the step ladder is moved from one location to another.

In U.S. Pat. No. 6,587,022 to R. M. Devine there is disclosed a foldable, portable, magnetic tool mat which may be mounted on the top step of a collapsible ladder. The tool mat includes generally rectangular obverse and reverse panels each formed of flexible material and connected together along substantially common side and end margins and along evenly spaced apart seam lines extending between said side margins defining elongated magnet bar holding portions. An elongated permanent magnet bar is held within each holding portion each without substantially inhibiting selective tool mat folding for fit and storage. The reverse panel is substantially thicker than the obverse panel for better wear characteristics and maximal magnet attractive forces for tool and hardware retention. An attaching strap holds the tool mat.

In U.S. Pat. No. 5,624,093 to R. W. Gemmell there is disclosed a paint tray assembly which includes a ladder clamp to secure the tray to a ladder or scaffold and magnetic holder and swing away rod providing mechanism for retaining paint brushes in the tray. A detachable handle attaches to the tray to permit relocation of the tray from one area to another minimizing the possibility of unwanted spillage of paint from the tray.

In U.S. Pat. No. 5,098,052 to D. L. Beck there is disclosed a tray member including at least one pair of opposite side margin depending flanges and a center downwardly recessed portion whose undersurface is co-planar with the lower edges of the depending flanges. The downwardly recessed center portion defines an upwardly opening recess in which to receive the lower end of a paint can and the tray member includes widely spaced apart depending threaded shanks from which a clamp bar is supported through the utilization of wing nuts threadedly engaged on the shanks. The tray member may be slid into position on the horizontal shelf of a step ladder and removably clamp engaged with the shelf by tightening the wing nuts in order to clamp the shelf between the clamp bar and the underside of the tray member. In addition, the upper surface of the downwardly recessed central portion of the tray member as well as the upper surfaces of the tray member disposed about the downwardly recessed central portion of the tray member are covered with magnetized panels, whereby ferris material items placed thereon will be magnetically held-in position on the tray member.

In U.S. Publication No. US002/0070137A1 to K. Hedger there is disclosed a tool and material holder fitting to the top of a step ladder which has selectable detachable panels having and presenting an extremely large number of variously selectable pockets, cavities, loops, clips, hanger, hooks and the like which securely hold a great variety of power and hand tools, caulking guns, paint brushed and paint pads. The holder is stiffened by internal tubes and sheet preferably made from strong shape-retentive plastic, and will stand upright upon the floor. A major loop maintained open by an insert with a shape memory holds a large paint pail, bucket or can, and is optionally re-sizable to hold one or two smaller cans. A shallow reservoir on a top panel overlying the top step of the step ladder has a magnetic bottom for conveniently holding small ferrous items. A detachable strap and shoulder harness permits great loaded weight to be conveniently and safely carried.

Other patents and patent applications of interest include U.S. Pat. No. 5,301,822 to E. S. Coleman et al; U.S. Pat. No. 5,500,631 to J. A. Negus; U.S. Pat. No. 6,341,666 to B. W. Allen; U.S. Pat. No. 6,614,337 to S. D. Winnad; U.S. Pat. No. 6,637,782 to C. D. McCoy et al; U.S. Pat. No. 6,698,699 to R. B. Bailey; and U.S. Patent Application Pub. No. 2004/0020716 to J. C. Carly.

Accordingly, it is an object of this invention to provide a step ladder having a top step which is adapted to prevent metallic tools or materials from sliding or rolling off of the top step.

It is another object of the invention to provide a step ladder having a top step wherein various ferrous material objects may be removably and stationarily supported thereon against accidental dislodgement therefrom.

Other objects and advantages of this invention will become apparent from the following description taken in connection with the accompanying drawings, wherein is set forth by way of illustration and example, embodiments of this invention.

### SUMMARY OF THE INVENTION

A step ladder constructed according to the teachings of this invention comprises a pair of rear legs, a pair of front legs, a plurality of steps attached to said rear legs and a plurality of cross-pieces attached to the front legs. The plurality of steps includes a top step, which is also attached to said pair of front legs, some intermediate steps and a bottom step. The top step includes a plate made of plastic, the plate having a top surface and a bottom surface. The top step also includes magnetic means for magnetically holding ferrous objects which may be placed on the top surface of the plastic plate. The magnetic means is permanently fixed to the plastic plate.

The magnetic means may either comprise one or more permanent bar magnets or a plurality of magnetic particles or one or more panels of magnetic sheeting. The magnetic means may either be imbedded into the plastic plate, attached to the bottom surface of the plastic plate or attached to the top surface of the plastic plate.

Various other features and advantages will appear from the description to follow. In the description, reference is made to the accompanying drawings which form a part thereof, and in which is shown by way of illustration, various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1 is a fragmentary pictorial perspective view of one embodiment of a step ladder constructed according to this invention, one of the rear legs in the step ladder being broken away at the bottom for convenience;

FIG. 2 is an enlarged plan view taken from the top and partly broken away of the top step in the folding step ladder shown in FIG. 1;

FIG. 3 is an enlarged sectional view taken substantially upon the plane indicated by section line 3-3 of FIG. 2;

FIG. 4 is a perspective view partly broken away of a modification of the top step in the step ladder in FIG. 1;

FIG. 5 is a perspective view of another modification of the top step in the step ladder in FIG. 1;

FIG. 6 is a bottom view of the top step shown in FIG. 5;

FIG. 7 is a front view partly broken away of the top step shown in FIG. 6;

FIG. 8 is a perspective view of another modification of the top step shown in FIG. 1;

FIG. 9 is a plan view taken from the top of the top step shown in FIG. 8;

FIG. 10 is a section view taken along lines 10-10 in FIG. 9;

FIG. 11 is a perspective view of another modification of the top step shown in FIG. 1; and

FIG. 12 is a plan view taken from the bottom of the top step shown in FIG. 11;

FIG. 13 is a section view taken along lines 13 in FIG. 12.

FIG. 14 is a perspective view of another modification of the top step in the step ladder in FIG. 1;

FIG. 15 is a top view of the top step shown in FIG. 5;

FIG. 16 is a section view taken along lines 16-16 of the top step shown in FIG. 15;

FIG. 17 is a perspective view of another modification of the top step shown in FIG. 1;

FIG. 18 is a plan view taken from the top of the top step shown in FIG. 17;

FIG. 19 is a section view taken along lines 19-19 in FIG. 18.

### DETAILED DESCRIPTION OF THE PREFERRED EMBODIMENT

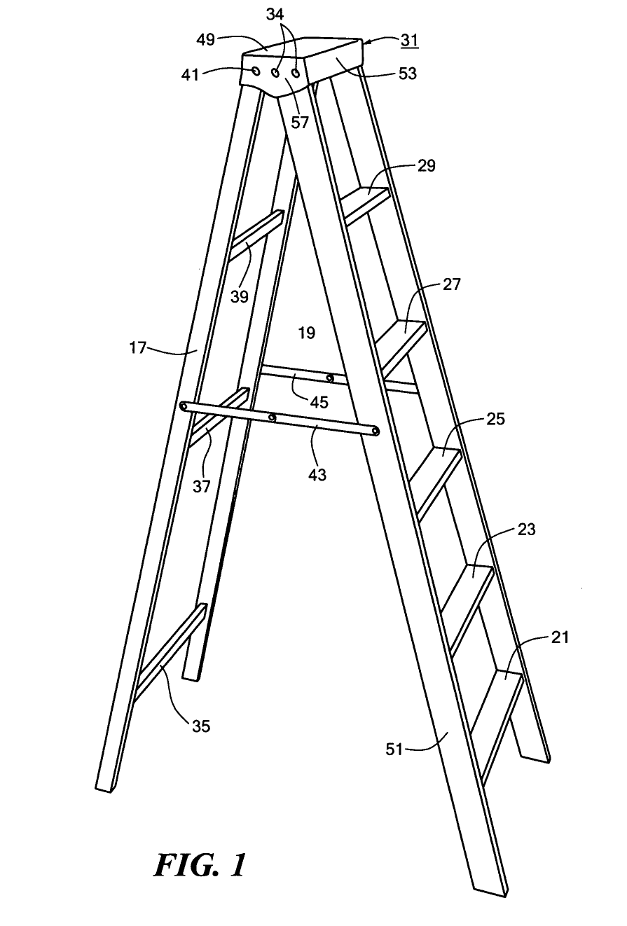

Referring now to the drawings, there is shown in FIG. 1 a step ladder 11 constructed according to this invention.

Step step ladder 11 includes a pair of rear legs 13 and 15 and a pair of front legs 17 and 19. A plurality of steps are fixedly attached to rear legs 13 and 15, at different levels, the plurality of steps including a bottom step 21, a plurality of intermediate steps 23, 25, 27 and 29 and a top step 31. Rear legs 13 and 15 are fixedly secured to top step 31 by fasteners 34. A plurality of cross pieces 35, 37 and 39 are fixedly attached to front legs 17 and 19 at different levels. Front legs 17 and 19 are pivotally mounted onto top step 31 by pivot fasteners 41, one on each side of top step 31. Front legs 17, 19 and rear legs 13, 15 are interconnected by hinge brackets 43 and 45.

As described thus far, ladder 11 is a conventional step ladder.

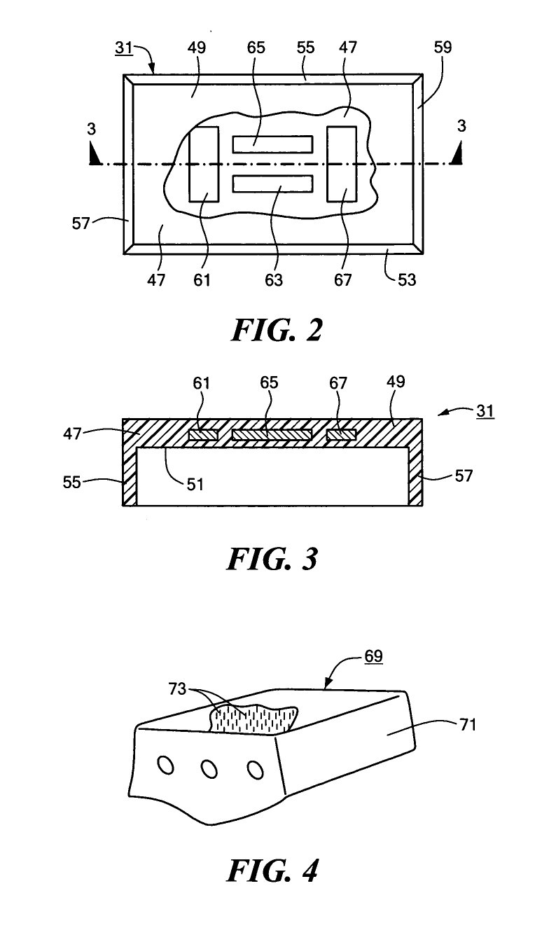

Referring now also to FIG. 2 and 3, top step 31 includes a generally rectangular plate 47 mad of a molded rigid plastic. Plate 47 has a top surface 49, a bottom surface 51, a front surface 53, a back surface 55 and side surfaces 57 and 59. A plurality of permanent unipolar bar magnets 61, 63, 65 and 67 of appropriate strength are imbedded in plate 47 between top surface 49 and bottom surface 51 for magnetically holding magnetically attractable objects such as metal screws or metal tools which may be placed on top surface 49 of plate 47. The number, size and exact location of magnets 61, 63, 65 and 67 within plate 47 are for illustrative purposes only.

In FIG. 4 is shown a modification of top step 31, the modification of top step 31, the modification being identified by reference numeral 69. Instead of bar magnets as in top step 31, top step 69 includes a generally rectangular plate 71 made of a molded rigid plastic which is similar in overall shape to top step 31 but which is imbedded with a plurality of magnetic particles 73 in the portion of top step 69 between its top surface and its bottom surface.

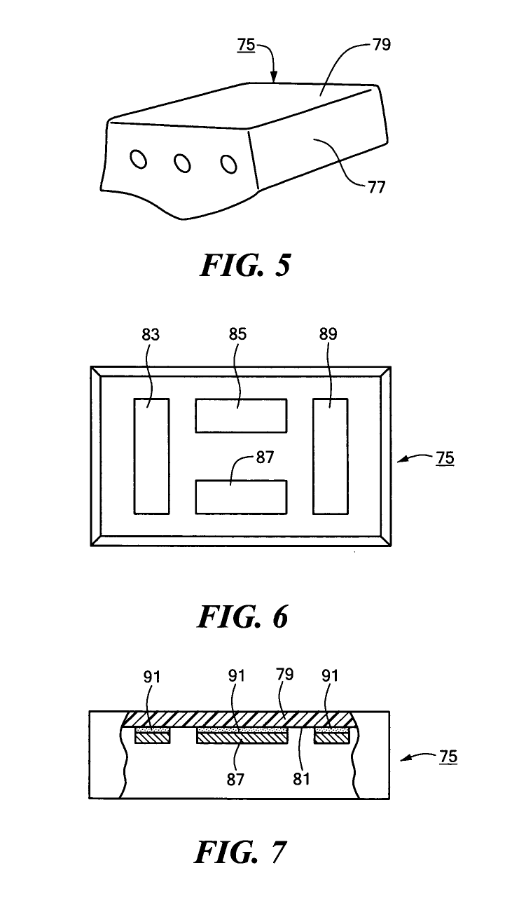

In FIGS. 5-7 is shown another modification of top step 31, the modification being identified by reference numeral 75. Top step 75 includes a generally rectangular plate 77 of a molded rigid plastic. Plate 77 includes a top surface 79 and a bottom surface 81. A plurality of permanent unipolar bar magnets 83, 85, 87 and 89 are fixedly secured by a suitable adhesive 91 to bottom surface 81 of top step 79.

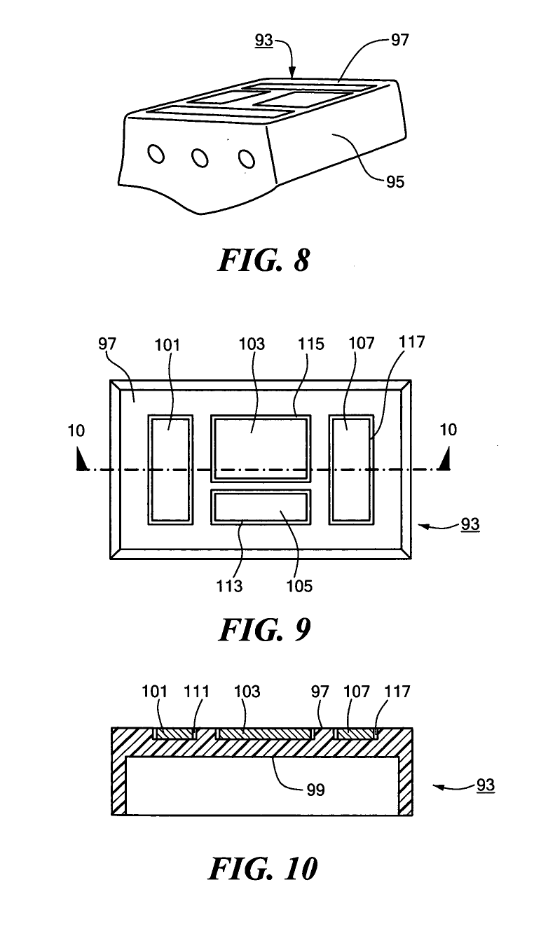

In FIGS. 8-10 is shown another modification of top step 31, the modification being identified by reference numeral 93. Top step 93 includes a generally rectangular plate 95 of a molded rigid plastic. Plate 95 includes a top surface 97 and a bottom surface 99. A plurality of permanent unipolar bar magnets 101, 103, 105 and 107 are fixedly secured by a suitable adhesive 109 to recesses 111, 113, 115 and 117 in top surface 97, the recesses and bar magnets being sized such that the top surfaces for the bar magnets are flush with top surface 97.

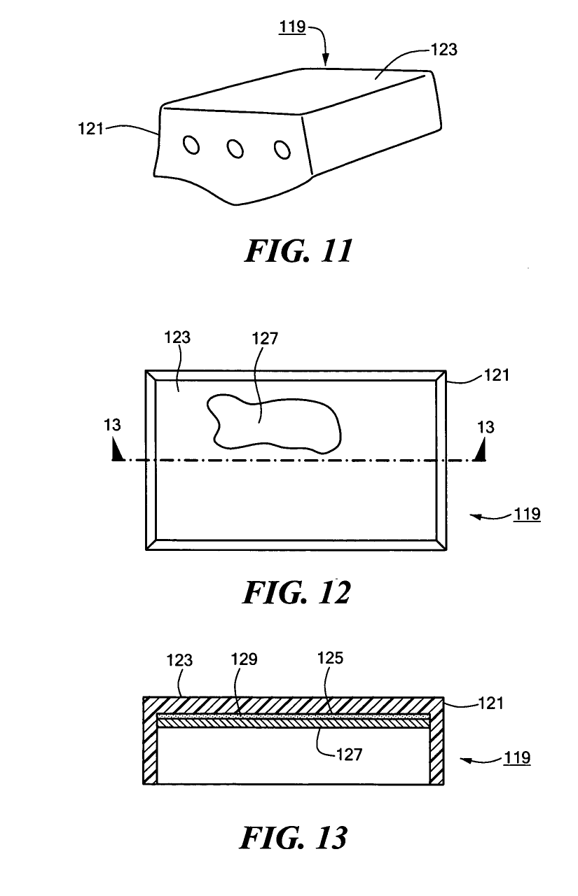

In FIGS. 11-13 is shown another modification of top step 31, the modification being identified by reference numeral 119. Top step 119 includes a generally rectangular plate 121 of a molded rigid plastic. Plate 121 includes a top surface 123 and a bottom surface 125. A panel of magnetized material 127 fixedly secured by a suitable adhesive 129 to bottom surface 125 of top step 119.

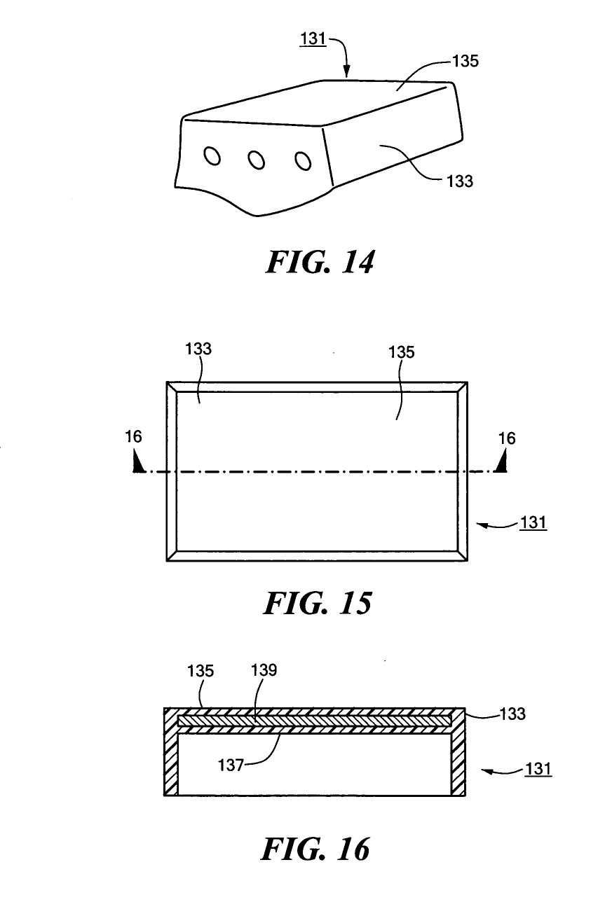

In FIGS. 14-15 is shown another modification of top step 31, the modification being identified by reference numeral 131. Top step 131 includes a generally rectangular plate 133 of a molded rigid plastic. Plate 133 includes a top surface 135 and a bottom surface 137. A panel of magnetized material 138 is imbedded in plate 135 between top surface 135 and bottom surface 137.

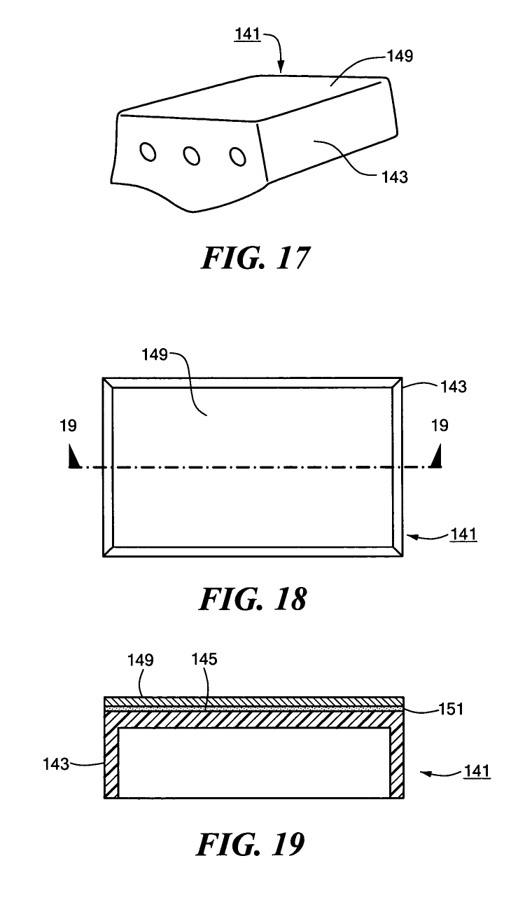

In FIGS. 17-19 is shown another modification of top step 31, the modification being identified by reference numeral 141. Top step 141 includes a generally rectangular plate 143 of a molded rigid plastic. Plate 143 includes a top surface 145 and a bottom surface 147. A panel of magnetized material 149 is fixedly secured by a suitable adhesive 151 to top surface 145 of top step 141.

Examples of panels of magnetized material may be found in U.S. Pat. Nos. 5,098,052; 6,614,337 and 6,637,792, which patents are incorporated herein by reference.

The embodiments shown in the present invention are intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A step ladder comprising:
(a) a pair of rear legs,
(b) a pair of front legs, and
(c) a plurality of steps attached to said rear legs,
(d) said plurality of steps including a top step which is also attached to said pair of front legs,
(e) said top step comprising a generally rectangular plate of plastic and magnetic means, said magnetic means being permanently fixed to said generally rectangular plate of plastic for magnetically holding ferrous objects on the top step which may be placed thereon.

2. The folding step ladder of claim 1 wherein said magnetic means comprises a bar magnet.

3. The folding step ladder of claim 2 wherein said bar magnet is imbedded in said top step.

4. The folding step ladder of claim 2 wherein said bar magnet is fixedly secured to the bottom surface of said top step.

5. The folding step ladder of claim 1 wherein said bar magnet is fixedly secured to the top surface in said top step.

6. The folding step ladder of claim 1 wherein said at least one magnet comprises a panel of magnetized material.

7. The folding step ladder of claim 6 wherein said panel of magnetized material is imbedded in said top step.

8. The folding step ladder of claim 6 wherein said panel of magnetized material is fixedly secured to the bottom surface of the top step.

9. The folding step ladder of claim 6 wherein said panel of magnetized material is fixedly secured to the top surface.

10. The folding step ladder of claim 1 wherein said magnetic means comprises a plurality of magnetic particles in said plate of plastic.

11. The folding step ladder of claim 6 wherein said panel is magnetized rubber sheeting.

12. A step ladder comprising:
(a) a pair of rear legs,
(b) a pair of front legs, and
(c) a plurality of steps attached to said rear legs,
(d) said plurality of steps including a top step which is also attached to said pair of front legs,
(e) said top step comprising:
(i) a plate of rigid material; and
(ii) a magnet permanently fixed to said plate.

13. A step ladder comprising:
(a) a pair of rear legs,
(b) a pair of front legs, and
(c) a plurality of steps attached to said rear legs,
(d) said plurality of steps including a top step which is also attached to said pair of front legs,
(e) said top step comprising a plate of rigid material having magnetic particles imbedded therein for magnetically holding ferrous objects which may be placed on said top step.
